(19) United States
(12) Patent Application Publication
(10) Pub. No.: US 2026/0302205 A1
(43) Pub. Date: Oct. 1, 2026

(54) POSITIVE ELECTRODE ACTIVE MATERIAL AND BATTERY

(71) Applicant: TOYOTA JIDOSHA KABUSHIKI KAISHA, Toyota-shi (JP)

(72) Inventor: Ryosuke OHSAWA, Okazaki-shi (JP)

(73) Assignee: TOYOTA JIDOSHA KABUSHIKI KAISHA, Toyota-shi (JP)

(21) Appl. No.: 19/438,098

(22) Filed: Dec. 31, 2025

(30) Foreign Application Priority Data
Mar. 25, 2025 (JP) 2025-049904

(51) Int. Cl. H01M 4/525; C01G 53/44; H01M 4/02; H01M 4/505; H01M 10/0525

(52) U.S. Cl. CPC H01M 4/525; C01G 53/44; H01M 4/505; H01M 10/0525; C01P 2004/80; C01P 2006/40; H01M 2004/021; H01M 2004/028

(57) ABSTRACT

A positive electrode active material has crystalline primary particles containing Li, a transition metal, and O, the positive electrode active material is a polycrystal made of the primary particles, a compound A containing La, Ni, and O and having a particle shape and a compound B containing Li, W, and O are present on a surface of the primary particles, a peak is present at 65 nm or less in a pore size distribution obtained by mercury intrusion porosimetry, and in a case where an average particle diameter of the polycrystal is defined as Dₐᵥₑ and a cumulative 50% particle diameter of the compound A is defined as d₅₀, the positive electrode active material satisfies 0.025≤d₅₀/Dₐᵥₑ≤2.0.

### CROSS-REFERENCE TO RELATED APPLICATION

This application claims priority to Japanese Patent Application No. 2025-049904 filed on Mar. 25, 2025. The disclosure of the above-identified application, including the specification, drawings, and claims, is incorporated by reference herein in its entirety.

### BACKGROUND

### 1. Technical Field

The present disclosure relates to a positive electrode active material and a battery.

### 2. Description of Related Art

In recent years, the development of a battery has been actively performed. For example, in the automotive industry, development of a battery used in a battery electric vehicle (BEV) is being carried out. In addition, development of a battery used in a plug-in hybrid electric vehicle (PHEV) or a hybrid electric vehicle (HEV) is being carried out. As a positive electrode active material used in a battery, an active material containing a transition metal such as Ni, Co, and Mn is known.

For example, Japanese Unexamined Patent Application Publication (Translation of PCT Application) No. 2022-542774 (JP 2022-542774 A) discloses a W-containing high-nickel ternary positive electrode material having a chemical formula of LiₐNiₓCo_{y}Mn_{1-x-y}W_{b}McO₂. The high-nickel ternary positive electrode material contains both spherical secondary particles and single crystal particles. The single crystal particles basically do not contain a W element, and the W element is doped into the spherical secondary particles.

Japanese Unexamined Patent Application Publication (Translation of PCT Application) No. 2024-511223 (JP 2024-511223 A) discloses a single crystal type multi-element positive electrode material. A ratio of a length of the longest diagonal line to a length of the shortest diagonal line of single crystal particles of the single crystal type multi-element positive electrode material, which is measured by SEM, is defined as a circularity R. R is 1 or more. D₁₀, D₅₀, and D₉₀ of the single crystal particles of the single crystal type multi-element positive electrode material satisfy K₉₀=(D₉₀−D₁₀)/D₅₀. A product of K₉₀ and R is 1.20 to 1.40.

### SUMMARY

From the viewpoint of improving battery performance, reducing resistance is desired. The present disclosure has been made in view of the above circumstances, and a main object of the present disclosure is to provide a positive electrode active material having reduced resistance.
(1) A positive electrode active material including primary particles that have crystallinity, the primary particles containing Li, a transition metal (TM), and O, in which the positive electrode active material is a polycrystal made of the primary particles,
a compound A containing La, Ni, and O and having a particle shape and a compound B containing Li, W, and O are present on a surface of the primary particles,
a peak is present at 65 nm or less in a pore size distribution obtained by mercury intrusion porosimetry, and
in a case where an average particle diameter of the polycrystal is defined as Dₐᵥₑ and a cumulative 50% particle diameter of the compound A is defined as d₅₀, the positive electrode active material satisfies 0.025≤d₅₀/Dₐᵥₑ≤2.0.
(2) The positive electrode active material according to (1), in which the primary particles contain, as the TM, at least one of Ni, Co, and Mn.
(3) The positive electrode active material according to (1) or (2), in which at least one of the compound A and the compound B is present at an interface between the primary particles adjacent to each other in the polycrystal.
(4) The positive electrode active material according to any one of (1) to (3), in which the compound B has a film shape.
(5) A battery including a positive electrode active material layer containing a positive electrode active material, a negative electrode active material layer containing a negative electrode active material, and an electrolyte layer disposed between the positive electrode active material layer and the negative electrode active material layer,
in which the positive electrode active material layer contains the positive electrode active material according to any one of (1) to (4).

The present disclosure has an effect of providing a positive electrode active material having reduced resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a positive electrode active material according to the present disclosure;

FIG. 2 is a schematic cross-sectional view illustrating primary particles according to the present disclosure;

FIG. 3 is a schematic cross-sectional view illustrating a battery according to the present disclosure; and

FIG. 4 is a flowchart illustrating a method of manufacturing the positive electrode active material in the present disclosure.

### DETAILED DESCRIPTION OF EMBODIMENTS

Hereinafter, an embodiment will be described with reference to the drawings. However, the present disclosure can be implemented in many different aspects, and is not limited to the description of the embodiments described below. In addition, the drawings may schematically show each part in terms of width, thickness, and shape in order to make the description more clear, as compared with the actual form, but this is merely an example and is not limited.

### A. Positive Electrode Active Material

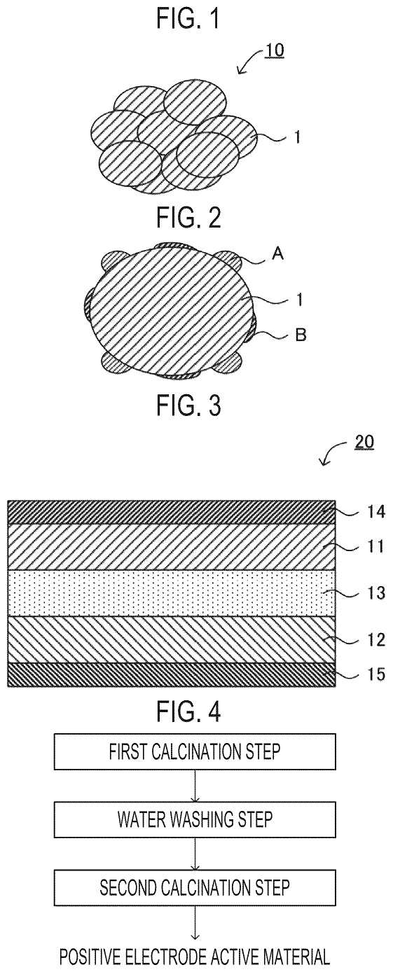

FIG. 1 is a schematic cross-sectional view illustrating a positive electrode active material according to the present disclosure. FIG. 2 is a schematic cross-sectional view illustrating the positive electrode active material according to the present disclosure. As shown in FIG. 1, a positive electrode active material 10 has crystalline primary particles 1 containing Li, TM (TM is a transition metal), and O. In addition, the positive electrode active material 10 is a polycrystal made of primary particles 1. In addition, as shown in FIG. 2, a compound A containing La, Ni, and O and having a particle shape and a compound B containing Li, W, and O are present on a surface of the primary particles 1. In addition, in the positive electrode active material 10, a peak is present at 65 nm or less in a pore size distribution obtained by mercury intrusion porosimetry. Further, in a case where an average particle diameter of the polycrystal is defined as Dₐᵥₑ and a cumulative 50% particle diameter of the compound A is defined as d₅₀, d₅₀/Dₐᵥₑ is in a specific range.

According to the present disclosure, since the compound A having favorable electron conductivity (compound containing La, Ni, and O) is present on the surface of the primary particles, it is possible to reduce resistance. In addition, in the present disclosure, since the compound B having favorable ion conductivity (compound containing Li, W, and O) is present on the surface of the primary particles, it is possible to reduce resistance. In addition, in the pore size distribution of the polycrystal, a peak is present at 65 nm or less. That is, the primary particles constituting the polycrystal are densely aggregated. In addition, since d₅₀/Dₐᵥₑ is in a predetermined range, the effect of improving the electron conductivity by the compound A is further exhibited.

### 1. Primary Particle

The primary particles in the present disclosure are crystalline particles containing Li, TM (TM is a transition metal), and O. Examples of the crystal structure of the primary particles include a layered rock salt type and a spinel type, and the layered rock salt type is preferable. In addition, the primary particles may have a crystal structure belonging to a space group R-3m.

The primary particles contain Li, TM (TM is a transition metal), and O. The primary particles may contain one kind of transition metal, may contain two kinds of transition metals, may contain three kinds of transition metals, or may contain four or more kinds of transition metals.

The transition metal is a metal belonging to Group 3 to Group 11 in the periodic table. The transition metal contained in the primary particles may be a metal belonging to the third period, the fourth period, or the fifth period. Examples of the transition metal include Ti, V, Cr, Mn, Fe, Co, Ni, Zr, Nb, La, and W.

It is preferable that the primary particles contain at least Ni. This is because a positive electrode active material having favorable capacity characteristics can be obtained. In a case where all the transition metals (TM) contained in the primary particles are defined as 1 part by mole, a proportion of Ni contained in the primary particles is, for example, 0.25 parts by mole or more. In a case where all the transition metals (TM) contained in the primary particles are defined as 1 part by mole, a proportion of Ni contained in the primary particles may be 0.33 parts by mole or more. In a case where all the transition metals (TM) contained in the primary particles are defined as 1 part by mole, a proportion of Ni contained in the primary particles may be 0.50 parts by mole or more. In a case where all the transition metals (TM) contained in the primary particles are defined as 1 part by mole, a proportion of Ni contained in the primary particles may be 0.75 parts by mole or more. In a case where all the transition metals (TM) contained in the primary particles are defined as 1 part by mole, a proportion of Ni contained in the primary particles may be 0.80 parts by mole or more. In a case where all the transition metals (TM) contained in the primary particles are defined as 1 part by mole, a proportion of Ni contained in the primary particles may be 0.90 parts by mole or more. By increasing the proportion of Ni, the capacity characteristics are improved.

The primary particles may contain Co or may not contain Co. In a case where all the transition metals (TM) contained in the primary particles are defined as 1 part by mole, a proportion of Co contained in the primary particles is, for example, 0 parts by mole or more, and may be 0.05 parts by mole or more or 0.10 parts by mole or more. On the other hand, the proportion of Co contained in the primary particles is, for example, 0.40 parts by mole or less, and may be 0.20 parts by mole or less.

The primary particles may contain Mn or may not contain Mn. In a case where all the transition metals (TM) contained in the primary particles are defined as 1 part by mole, a proportion of Mn contained in the primary particles is, for example, 0 parts by mole or more, and may be 0.05 parts by mole or more or 0.10 parts by mole or more. On the other hand, the proportion of Mn contained in the primary particles is, for example, 0.40 parts by mole or less, and may be 0.20 parts by mole or less.

It is preferable that the primary particles contain at least one of Ni, Co, and Mn. In a case where all the metals (excluding Li) contained in the primary particles are defined as 1 part by mole, a total proportion of Ni, Co, and Mn contained in the primary particles may be, for example, 0.80 parts by mole or more. In a case where all the metals (excluding Li) contained in the primary particles are defined as 1 part by mole, a total proportion of Ni, Co, and Mn contained in the primary particles may be, for example, 0.90 parts by mole or more, or 0.95 parts by mole or more. It is noted that the “total of Ni, Co, and Mn” also includes a case where the proportion of one or two of Ni, Co, and Mn is 0.

The primary particles may contain a metal M¹ (including a metalloid) other than Li and TM in addition to Li and TM. Examples of the other metal M¹ include a metal belonging to Group 12 to Group 14 in the periodic table. Examples of the metal belonging to Group 12 to Group 14 include Zn, Al, Si, Ga, Ge, In, and Sn.

A composition of the primary particles is not particularly limited. The composition of the primary particles may be, for example, a composition represented by General Formula LiₓNiₐCo_{b}Mn_{c}O_{y} (0.1≤x≤1.5, 0.5≤a≤1.0, 0≤b≤0.3, 0≤c≤0.3, 0.001≤d≤0.1, 0.001≤e≤0.1, a+b+c+d+e=1.0, 1.5≤y≤2.1).

### 2. Compound A

The compound A in the present disclosure contains La, Ni, and O. Since the compound A usually has high electron conductivity, the compound A is present on the surface of the primary particles, whereby the resistance can be reduced. The compound A may be directly disposed on the surface of the primary particles or may be disposed through another layer (another compound), but the former is preferable.

The compound A contains at least La, Ni, and O. The compound A may be made of only La, Ni, and O, or may further contain other elements. Examples of the other elements include Li. That is, the compound A may contain Li or may not contain Li. Examples of the composition of the compound A include LaₐNi_{b}O_{c} (0.8≤a≤1.2, 0.8≤b≤1.2, 2.8≤c≤3.2). For example, LaNiO₃ has a typical perovskite composition and favorable electron conductivity. Examples of the composition of the compound A include LaₐLi_{b}Ni_{c}O_{d} (3.5≤a≤4.5, 0.5≤b≤1.5, 0.5≤c≤1.5, 7.5≤d≤8.5). For example, it is known that La₄LiNiO₈ has favorable electron conductivity, and it is assumed to have a crystal phase similar to perovskite.

The compound A may be crystalline or may be amorphous, but the former is preferable. This is because favorable electron conductivity can be obtained. The “compound is crystalline” means that a peak derived from the compound to be examined is confirmed by X-ray diffraction using a CuKα ray. On the other hand, the “compound is amorphous” means that a peak derived from the compound to be symmetrical is not confirmed by X-ray diffraction using a CuKα ray. It is noted that, in a case where the target compound is amorphous, a halo pattern may be observed instead of the peak.

The compound A preferably has a perovskite crystal phase or a crystal phase similar to perovskite. It is preferable that the compound A has at least one crystal phase of LaNiO₃ or La₄LiNiO₈. This is because favorable electron conductivity can be obtained. It is noted that the crystal phase includes a crystal phase in which a part of the constituent atoms (for example, a part of O atoms) is deficient and a crystal phase in which a part of the constituent atoms (for example, a part of La atoms) is in surplus.

It is preferable that the compound A has a particle shape. The “compound A has a particle shape” means the following. In a cross-sectional image of the primary particles, a length of the compound A in a normal direction of the surface of the primary particles is defined as L₁. A length of the compound A in a direction perpendicular to the normal direction is defined as L₂. In this case, a ratio (L₂/L₁) of L₂ to L₁ is 3.0 or less, which is defined as “the compound A has a particle shape”. The cross-sectional image of the primary particles is, for example, an SEM cross-sectional image.

In a case where all the transition metals contained in the primary particles are set to 1 part by mole, a proportion of La contained in the compound A is, for example, 0.001 parts by mole or more, and may be 0.003 parts by mole or more, or 0.005 parts by mole or more. On the other hand, the above-described proportion of La contained in the compound A is, for example, 0.100 parts by mole or less, and may be 0.080 parts by mole or less, or 0.060 parts by mole or less.

A coating rate of the compound A on the primary particles is not particularly limited, but is, for example, 10% or more and 90% or less, and may be 20% or more and 80% or less, or 30% or more and 70% or less. The coating rate of the compound A can be determined from, for example, an analysis of a top surface by X-ray photoelectron spectroscopy (XPS). For example, in a case where the primary particles contain Ni, Co, and Mn as the transition metal TM, the La amount and each TM amount (Ni amount, Co amount, and Mn amount) can be determined by the analysis of the top surface by XPS, and La/(La+TM) can be used as the coating rate. The coating rate of the compound B can also be determined in the same manner. In addition, the electron conductivity of the compound A is usually higher than the electron conductivity of La₂O₃. The electron conductivity of the compound A at 25° C. is, for example, 5.0×10⁻⁴ S/cm or more, and may be 1.0×10⁻³ S/cm or more. In addition, the compound A (compound containing La, Ni, and O) is disposed on the surface of the primary particles. The primary particles may contain La or may not contain La.

### 3. Compound B

The positive electrode active material in the present disclosure may have a compound B containing Li, W, and O on the surface of the primary particles. Since the compound B usually has high ion conductivity, the compound B is present on the surface of the primary particles, whereby the resistance can be reduced. In addition, since the compound B is present on the surface of the primary particles, an increase in resistance over time can be suppressed. The compound B may be directly disposed on the surface of the primary particles or may be disposed through another layer (another compound), but the former is preferable.

The compound B contains at least Li, W, and O. The compound B may be made of only Li, W, and O, or may further contain other elements. Examples of the composition of the compound B include LiₐW_{b}O_{c} (5.5≤a≤6.5, 0.5≤b≤1.5, 5.5≤c≤6.5). The compound B having the above-described composition is typically Li₆WO₆. Examples of the composition of the compound B include LiₐW_{b}O_{c} (1.5≤a≤2.5, 0.5≤b≤1.5, 3.5≤c≤4.5). The compound B having the above-described composition is typically Li₂WO₄. In addition, examples of the composition of the compound B include LiₐW_{b}O_{c} (3.5≤a≤4.5, 0.5≤b≤1.5, 4.5≤c≤5.5). The compound B having the above-described composition is typically Li₄WO₅. In addition, examples of the composition of the compound B include LiₐW_{b}O_{c} (1.5≤a≤2.5, 1.5≤b≤2.5, 6.5≤c≤7.5). The compound B having the above-described composition is typically Li₂W₂O₇.

The compound B may be crystalline or may be amorphous. In addition, it is preferable that the compound B has a film shape. The “compound B has a film shape” means the following. In a cross-sectional image of the primary particles, a length of the compound B in a normal direction of the surface of the primary particles is defined as L₃. A length of the compound B in a direction perpendicular to the normal direction is defined as L₄. In this case, a ratio (L₄/L₃) of L₄ to L₃ is greater than 3.0, which is defined as “the compound B has a film shape”. The cross-sectional image of the primary particles is, for example, a transmission electron microscope (TEM) cross-sectional image. A thickness (length L₃) of the compound B is not particularly limited, but is, for example, 0.5 nm or more and 20 nm or less, and may be 1 nm or more and 15 nm or less. The thickness of the compound B is obtained as an average value measured at least at five locations in the observation by TEM.

In a case where all the transition metals contained in the primary particles are set to 1 part by mole, a proportion of W contained in the compound B is, for example, 0.001 parts by mole or more, and may be 0.003 parts by mole or more, or 0.005 parts by mole or more. On the other hand, the above-described proportion of W contained in the compound B is, for example, 0.100 parts by mole or less, and may be 0.080 parts by mole or less, or 0.060 parts by mole or less.

A coating rate of the compound B on the primary particles is not particularly limited, but is, for example, 10% or more and 90% or less, and may be 20% or more and 80% or less, or 30% or more and 70% or less. In addition, the ion conductivity of the compound B is usually higher than the ion conductivity of W₂O₃. The ion conductivity of the compound B at 25° C. is, for example, 1.0×10⁻⁵ S/cm or more, and may be 1.0×10⁻⁴ S/cm or more. In addition, the compound B (compound containing Li, W, and O) is disposed on the surface of the primary particles. The primary particles may contain W or may not contain W.

### 4. Polycrystal

The positive electrode active material in the present disclosure is a polycrystal made of the primary particles. As shown in FIG. 1, the positive electrode active material 10 is made of the primary particles 1. The number of primary particles constituting the polycrystal is not particularly limited, but is, for example, 10 or more and 500 or less.

In a case where a pore size distribution of the positive electrode active material in the present disclosure is measured by mercury intrusion porosimetry, a peak is usually present at 65 nm or less. The above-described peak also includes an inflection point. The above-described peak may be present in a range of less than 30 nm. A pore amount at the above-described peak is, for example, 0.005 mL/g or more, and may be 0.010 mL/g or more or 0.015 mL/g or more. The pore amount at the above-described peak is, for example, 0.030 mL/g or less.

In the present disclosure, an average particle diameter of the polycrystal is defined as Dₐᵥₑ. The average particle diameter of the polycrystal is measured at 50 points by a scanning electron microscope (SEM) to measure the maximum length of the polycrystal. From the 50 measured numerical values, the first to fifth largest numerical values and the first to fifth smallest numerical values are excluded, and the average of the remaining 40 points is defined as Dₐᵥₑ. In addition, in a particle size distribution of the compound A, a cumulative 10% particle diameter is defined as d₁₀, a cumulative 50% particle diameter of the compound A is defined as d₅₀, and a cumulative 90% particle diameter of the compound A is defined as d₉₀, from a low particle diameter side. The particle size distribution of the compound A can be measured by, for example, small angle X-ray scattering (SAXS).

The positive electrode active material usually satisfies 0.025≤d₅₀/Dₐᵥₑ≤2.0. d₅₀/Dₐᵥₑ may be 0.03 or more, 0.1 or more, 0.25 or more, 0.5 or more, 0.75 or more, or 1.0 or more. On the other hand, d₅₀/Dₐᵥₑ may be 1.8 or less, 1.7 or less, 1.6 or less, or 1.5 or less.

Dₐᵥₑ is, for example, 0.5 μm or more, and may be 1.0 μm or more, 1.5 μm or more, or 2.0 μm or more. On the other hand, Dₐᵥₑ is, for example, 30 μm or less, and may be 25 μm or less or 20 μm or less. In addition, Dₐᵥₑ may be in the vicinity of 2.0 μm (for example, 0.5 μm or more and 5.0 μm or less). On the other hand, d₅₀ is, for example, 0.3 μm or more, and may be 0.5 μm or more, 1.0 μm or more, 1.5 μm or more, or 2.0 μm or more. On the other hand, the d₅₀ is, for example, 10 μm or less, may be 8 μm or less, may be 5 μm or less, and may be 3 μm or less. In addition, d₅₀ may be in the vicinity of 2.0 μm to 3.0 μm (for example, 1.0 μm or more and 4.0 μm or less).

The positive electrode active material may satisfy 3.0≤(d₉₀−d₁₀)/d₅₀. As the value of (d₉₀−d₁₀)/d₅₀ is larger, the particle diameter of the compound A is more non-uniform. In a case where the particle diameter of the compound A is non-uniform, the initial resistance and the cycle resistance increase rate tend to decrease. (d₉₀−d₁₀)/d₅₀ may be 3.5 or more and 3.9 or less. In addition, in the present disclosure, at least one of the compound A and the compound B may be present at an interface between the primary particles adjacent to each other in the polycrystal.

### 5. Positive Electrode Active Material

The positive electrode active material in the present disclosure has crystalline primary particles containing Li, a transition metal (TM), and O. In addition, the positive electrode active material is a polycrystal made of the primary particles. The positive electrode active material is usually used in a battery. In addition, a method of manufacturing the positive electrode active material is not particularly limited, and examples thereof include a method described in “D. Method of Manufacturing Positive Electrode Active Material” described later.

In addition, the present disclosure can provide the following positive electrode active material powder. The positive electrode active material powder contains the crystalline primary particles containing Li, a transition metal (TM), and O as the positive electrode active material. At least a part of the primary particles constitutes the polycrystal. A compound A containing La, Ni, and O and a compound B containing Li, W, and O are present on a surface of the primary particles constituting the polycrystal. In the pore size distribution of the polycrystal obtained by mercury intrusion porosimetry, a peak is present at 65 nm or less. In a case where an average particle diameter of the polycrystal is defined as Dₐᵥₑ and a cumulative 50% particle diameter of the compound A constituting the polycrystal is defined as d₅₀, the polycrystal satisfies 0.025≤d₅₀/Dₐᵥₑ≤2.0. A part of the primary particles may constitute a single crystal active material. In addition, a proportion of the polycrystal to all the positive electrode active materials in the positive electrode active material powder is, for example, 5% by mass or more, and may be 10% by mass or more or 20% by mass or more. The proportion of the polycrystal to all the positive electrode active materials in the positive electrode active material powder may be, for example, 30% by mass or more, 40% by mass or more, or 50% by mass or more. The proportion of the polycrystal to all the positive electrode active materials in the positive electrode active material powder may be, for example, 60% by mass or more, or 70% by mass or more.

### B. Positive Electrode Mixture

In the present disclosure, a positive electrode mixture containing the above-described positive electrode active material can also be provided.

According to the present disclosure, the positive electrode mixture having reduced resistance can be obtained by using the above-described positive electrode active material. The positive electrode mixture may contain other materials (for example, a conductive material and a binder) in addition to the positive electrode active material. In addition, the positive electrode mixture may contain the above-described positive electrode active material powder. In addition, the positive electrode mixture may be in a powder form or may be in a slurry form containing a dispersion medium.

A proportion of the positive electrode active material in the solid content of the positive electrode mixture is, for example, 20% by mass or more, and may be 30% by mass or more or 40% by mass or more. In a case where the proportion of the positive electrode active material is too small, there is a possibility that a sufficient energy density cannot be obtained. On the other hand, the proportion of the positive electrode active material in the solid content of the positive electrode mixture is, for example, 95% by mass or less, and may be 70% by mass or less or 60% by mass or less. In a case where the proportion of the positive electrode active material is too large, the ion conductivity and the electron conductivity may be relatively reduced.

The positive electrode mixture may contain a conductive material. By adding the conductive material, the electron conductivity is improved. Examples of the conductive material include a carbon-based conductive material, metal particles, and a conductive polymer. Examples of the carbon-based conductive material include particle-shaped materials such as acetylene black (AB) and ketjen black (KB), and fiber-shaped materials such as vapor-grown carbon fiber (VGCF), carbon nanotube (CNT), and carbon nanofiber (CNF).

The positive electrode mixture may contain a binder. By adding the binder, a positive electrode active material layer in which the positive electrode active material is less likely to fall off is obtained. Examples of the binder include rubber-based binders such as styrene-butadiene rubber (SBR) and butadiene rubber (BR). Examples of the binder include a polycarboxylic acid-based binder such as carboxymethyl cellulose, and a fluorinated binder such as polyvinylidene fluoride (PVdF).

### C. Battery

FIG. 3 is a schematic cross-sectional view illustrating the battery according to the present disclosure. A battery 20 shown in FIG. 3 has a positive electrode active material layer 11 and a negative electrode active material layer 12. The battery 20 has an electrolyte layer 13 disposed between the positive electrode active material layer 11 and the negative electrode active material layer 12. The battery 20 has a positive electrode current collector 14 that collects current from the positive electrode active material layer 11, and a negative electrode current collector 15 that collects current from the negative electrode active material layer 12. In the present disclosure, the positive electrode active material layer 11 contains the positive electrode active material described in “A. Positive Electrode Active Material” or the positive electrode mixture described in “B. Positive Electrode Mixture”.

According to the present disclosure, the battery having reduced resistance can be obtained by using the above-described positive electrode active material or positive electrode mixture.

### 1. Positive Electrode Active Material Layer

The positive electrode active material layer contains at least the positive electrode active material. In addition, the positive electrode active material layer may contain a conductive material and a binder. The positive electrode active material, the conductive material, and the binder are the same as those described in “A. Positive Electrode Active Material” and “B. Positive Electrode Mixture” described above.

The positive electrode active material layer may contain an electrolyte. The electrolyte is, for example, an electrolytic solution described later. On the other hand, the positive electrode active material layer may contain a solid electrolyte. A thickness of the positive electrode active material layer is, for example, 0.1 μm or more and 1,000 μm or less, and may be 1 μm or more and 500 μm or less, or 30 μm or more and 100 μm or less.

### 2. Negative Electrode Active Material Layer

The negative electrode active material layer contains at least the negative electrode active material. Examples of the negative electrode active material include a carbon-based active material, an Li-based active material, an Si-based active material, and an oxide-based active material.

Examples of the carbon-based active material include graphite, soft carbon, and hard carbon. The graphite may be natural graphite or artificial graphite. Examples of the Li-based active material include Li and a Li alloy. Examples of the Li alloy include a Li—Si alloy. Examples of the Si-based active material include Si, a SiC composite active material, an Si alloy, and an Si oxide. Examples of the SiC composite active material include an active material in which Si or an Si alloy is supported on a carbon carrier. Examples of the oxide-based active material include lithium titanate such as Li₄Ti₅O₁₂.

The negative electrode active material layer may contain at least one of a conductive material, a binder, and an electrolyte. Details of the conductive material, the binder, and the electrolyte are the same as those described in “1. Positive Electrode Active Material Layer” described above. In addition, a thickness of the negative electrode active material layer is, for example, 0.1 μm or more and 1,000 μm or less, and may be 1 μm or more and 500 μm or less, or 30 μm or more and 100 μm or less.

### 3. Electrolyte Layer

The electrolyte layer is a layer disposed between the positive electrode active material layer and the negative electrode active material layer, and contains at least an electrolyte. The electrolyte is, for example, a liquid electrolyte (electrolytic solution).

Examples of the electrolytic solution include a non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆. Examples of the lithium salt include organic lithium salts such as LiCF₃SO₃, LiN(SO₂CF₃)₂, LiN(SO₂C₂F₅)₂, and LiC(SO₂CF₃)₃.

Examples of the non-aqueous solvent include carbonate-based solvents such as ethylene carbonate (EC), propylene carbonate (PC), butylene carbonate (BC), and dimethyl carbonate (DMC). Examples of the non-aqueous solvent include carbonate-based solvents such as diethyl carbonate (DEC) and ethyl methyl carbonate (EMC). The non-aqueous electrolytic solution may contain an ionic liquid. In addition, examples of the electrolytic solution include an aqueous electrolytic solution. Further, the electrolyte layer may include a separator impregnated with the above-described electrolytic solution.

### 4. Battery

The battery according to the present disclosure preferably includes a positive electrode current collector which collects current of the positive electrode active material layer and a negative electrode current collector which collects current of the negative electrode active material layer.

A type of the battery according to the present disclosure is not particularly limited, but is typically a lithium-ion battery. In addition, the battery according to the present disclosure may be a primary battery or may be a secondary battery, but the battery is preferably a secondary battery. It is because a secondary battery can be repeatedly charged and discharged and is useful, for example, as an in-vehicle battery. Examples of an application of the battery include a power source of a vehicle such as a hybrid electric vehicle (HEV) and a plug-in hybrid electric vehicle (PHEV). Examples of an application of the battery include a power source of a vehicle such as a battery electric vehicle (BEV), a gasoline vehicle, and a diesel vehicle. In particular, it is preferably used as a drive power source of a hybrid electric vehicle (HEV). In particular, it is preferably used as a drive power source of a plug-in hybrid electric vehicle (PHEV) or a battery electric vehicle (BEV). The battery may be used as a power source of a moving body other than a vehicle (for example, a train, a ship, or an airplane), or may be used as a power source of an electrical product, such as an information processing device.

### D. Method of Manufacturing Positive Electrode Active Material

In the present disclosure, a method of manufacturing a positive electrode active material, which manufactures the above-described positive electrode active material, can also be provided. As shown in FIG. 4, the method of manufacturing a positive electrode active material preferably includes a first calcination step of calcining a first mixture containing a transition metal hydroxide containing the above-described TM, a Li source, and a W source at a temperature Ti to obtain a first calcined product. The method of manufacturing a positive electrode active material preferably includes a water washing step of adding the pulverized product of the first calcined product to water, stirring the mixture at a water temperature of 10° C. or lower, and washing the mixture with water. The method of manufacturing a positive electrode active material preferably includes a second calcination step of adding a La source to the pulverized product of the first calcined product after the water washing to prepare a second mixture, and calcining the second mixture at a temperature T₂ to obtain a second calcined product. At least one of the first mixture and the second mixture usually contains a Ni source. The temperature T₂ is preferably lower than the temperature T₁.

According to the present disclosure, the positive electrode active material having reduced resistance can be obtained by performing the first calcination step, the water washing step, and the second calcination step.

### 1. First Calcination Step

The first calcination step is a step of calcining a first mixture containing a transition metal hydroxide containing the above-described TM, a Li source, and a W source at a temperature T₁ to obtain a first calcined product.

The transition metal hydroxide contains TM (TM is a transition metal). The transition metal hydroxide corresponds to a precursor of the positive electrode active material. The transition metal hydroxide may contain Ni or may not contain Ni.

A method of synthesizing the transition metal hydroxide is not particularly limited, but examples thereof include the following methods. First, an aqueous solution of a raw material of the transition metal hydroxide is prepared. Examples of a method of preparing the aqueous solution of a raw material include a method of dissolving a water-soluble transition metal compound in water. Examples of the transition metal compound include metal salts such as a sulfate and a nitrate. Examples of the Ni source include NiSO₄ and Ni(NO₃)₂. Examples of the Co source include CoSO₄, Co(NO₃)₂, and Co(NO₃)₃. Examples of the Mn source include MnSO₄ and Mn(NO₃)₂. A composition of the aqueous solution of a raw material is appropriately adjusted according to the positive electrode active material to be obtained.

Next, an aqueous sodium hydroxide solution is added to the reaction container, and the aqueous solution of a raw material and an aqueous ammonia solution are added dropwise while maintaining the pH in an alkaline range (for example, pH 11.3 to 12.0). A reaction temperature is not particularly limited, but is, for example, 50° C. or higher and 65° C. or lower. After the reaction is completed, it is preferable to filter the reaction solution to take out the transition metal hydroxide, and then wash the transition metal hydroxide with water and dry the transition metal hydroxide. A reaction time is, for example, 2 hours or longer and 12 hours or shorter. In a case where the reaction time is long, the amount of the supplied reaction raw material is large, and as a result, the average particle diameter of the polycrystal is large.

In the first calcination step, a first mixture containing a transition metal hydroxide, a Li source, and a W source is prepared. Examples of the Li source include lithium hydroxide, lithium carbonate, lithium nitrate, lithium acetate, lithium oxide, and lithium chloride. The Li source may be lithium hydroxide or may be a Li-containing compound other than lithium hydroxide. A molar ratio of Li in the Li source to the TM contained in the transition metal hydroxide is, for example, 0.8 or more and 1.2 or less, and may be 0.9 or more and 1.1 or less, or may be 1.0.

Examples of the W source include H₂WO₄. In addition, the first mixture may contain a Ni source or may not contain a Ni source. For example, in a case where the transition metal hydroxide contains Ni, the transition metal hydroxide may serve as the Ni source. On the other hand, in a case where the transition metal hydroxide does not contain Ni, it is necessary to use a Ni source separately. Examples of the Ni source include Ni(OH)₂, NiSO₄, and Ni(NO₃)₂. The addition amounts of the W source and the Ni source are appropriately adjusted according to the positive electrode active material to be obtained.

The mixture preferably has a molten salt. By functioning as a flux, the molten salt can sufficiently promote grain growth of the primary particles. The molten salt may contain L₁. Examples of the molten salt include lithium hydroxide. A molar ratio (Li/TM) of Li contained in the molten salt to the TM contained in the transition metal hydroxide is, for example, 0.1 or more and less than 0.6. Li/TM may be 0.15 or more, 0.2 or more, or 0.25 or more. On the other hand, Li/TM may be 0.55 or less, or may be 0.5 or less.

In the first calcination step, the first mixture is calcined at a temperature T₁ to obtain a first calcined product. The temperature T₁ is, for example, 500° C. or higher and 800° C. or lower, and may be 550° C. or higher and 750° C. or lower. In a case where the temperature T₁ is too high, W₂O₃ is likely to be generated instead of the compound B containing Li, W, and O, and it is difficult to reduce the resistance. On the other hand, in a case where the temperature T₁ is too low, it is difficult to promote sufficient grain growth of the primary particles.

A calcination time in the first calcination step is not particularly limited, but is, for example, 5 hours or longer and 15 hours or shorter, and may be 8 hours or longer and 12 hours or shorter. An atmosphere in the first calcination step is usually an atmosphere in which oxygen is present. Examples of a calcination method in the first calcination step include a method of using a calcining furnace such as a muffle furnace and an electric furnace.

In the first calcination step, a pulverization process of pulverizing the first calcined product may be performed. Examples of a pulverization method in the pulverization process include a jet mill, a hammer mill, a lab mill, and a ball mill.

### 2. Water Washing Step

The water washing step is a step of adding the pulverized product of the first calcined product to water, stirring the mixture at a water temperature of 10° C. or lower, and washing the mixture with water. By performing the water washing step, the compound B provided on the surface of the primary particles can be appropriately washed, and the particle diameter of the compound A to be provided in the second calcination step described later can be controlled. The water temperature during stirring may be lower than 7° C., may be 6° C. or lower, may be 4° C. or lower, or may be 2.5° C. or lower. In a case where the water temperature during stirring is low, W is less likely to be dissolved in water, and the exposed portion of the surface of the primary particles is reduced. Therefore, the area of the compound A adhering to the surface of the primary particles is reduced, and the compound A can adhere only to a limited portion, so that the particle diameter of the compound A is reduced. On the contrary, in a case where the water temperature during stirring is high, the particle diameter of the compound A is increased. In addition, in a case where the water temperature during stirring is low, as described above, the area of the compound A adhering to the surface of the primary particles is small, and the compound A can adhere only to a limited portion, so that the particle diameter of the compound A tends to be uniform. On the contrary, in a case where the water temperature during stirring is high, the compound A can adhere relatively freely, so that the particle diameter of the compound A tends to be non-uniform. In addition, a stirring time is not particularly limited, but is, for example, 15 minutes or longer and 60 minutes or shorter.

### 3. Second Calcination Step

The second calcination step is a step of adding a La source to the pulverized product of the first calcined product after the water washing to prepare a second mixture, and calcining the second mixture at a temperature T₂ to obtain a second calcined product. The temperature T₂ in the second calcination step is preferably lower than the temperature T₁ in the first calcination step. By setting the temperature T₂ lower than the temperature T₁, the compound A containing La, Ni, and O is likely to be generated instead of La₂O₃, and the resistance can be reduced.

Examples of the La source include: hydroxides; and metal salts such as sulfates and nitrates. Examples of the La source include La(OH)₃, LaSO₄, and La(NO₃)₃. The addition amount of the La source is appropriately adjusted according to the positive electrode active material to be obtained. In addition, the second mixture may contain a Ni source or may not contain a Ni source.

A difference between the temperature T₁ and the temperature T₂ is, for example, 25° C. or higher, and may be 50° C. or higher. In addition, the temperature T₂ is, for example, 500° C. or higher and 700° C. or lower, and may be 550° C. or higher and 650° C. or lower. In a case where the temperature T₂ is too high, La₂O₃ may be likely to be generated. On the other hand, in a case where the temperature T₂ is too low, the effect of improving the electron conductivity by the compound A may not be sufficiently obtained.

A calcination time in the second calcination step is, for example, 3 hours or longer and 7 hours or shorter, and may be 4 hours or longer and 6 hours or shorter. A calcination time in the second calcination step may be shorter than a calcination time in the first calcination step. An atmosphere in the second calcination step is usually an atmosphere in which oxygen is present. Examples of a calcination method in the second calcination step include a method of using a calcining furnace such as a muffle furnace and an electric furnace.

In the second calcination step, a pulverization process of pulverizing the second calcined product may be performed. Examples of a pulverization method in the pulverization process include a jet mill, a hammer mill, a lab mill, and a ball mill. It is preferable that the pulverization conditions are adjusted such that the polycrystal having a peak at a predetermined position in the pore size distribution is obtained.

### 4. Positive Electrode Active Material

The positive electrode active material obtained by each of the above-described steps is the same as the content described in “A. Positive Electrode Active Material” Described Above.

The present disclosure is not limited to the embodiment. The embodiment is an example and anything that has substantially the same configuration as the technical idea described in the claims of the present disclosure and produces the same effect is included in the technical scope of the present disclosure.

### Comparative Example 1

### Preparation of Positive Electrode Active Material

As a raw material, NiSO₄, CoSO₄, and MnSO₄ were prepared, and these were dissolved in ion exchange water to prepare a raw material aqueous solution. The proportion of Ni, Co, and Mn in the raw material aqueous solution was set to Ni:Co:Mn=8:1:1 in terms of a molar ratio. In addition, a concentration of the raw material aqueous solution (proportion of all raw materials to the raw material aqueous solution) was 30% by mass.

Thereafter, a certain amount of an aqueous ammonia solution was added to the reaction container, and the inside of the reaction container was replaced with nitrogen while stirring with a stirrer. An aqueous NaOH solution was added to the reaction container, the pH was maintained in an alkaline range (pH=12), and the raw material aqueous solution and the aqueous ammonia solution were added dropwise while controlling the temperature to a certain temperature, thereby precipitating a transition metal hydroxide. The reaction temperature was 60° C., and the reaction time was 6 hours. Next, the precipitated transition metal hydroxide was taken out by filtration, and washed with water by adding ion exchange water and dispersing with a spoon. The transition metal hydroxide after washing with water was dried under the conditions of 120° C. and 16 hours to obtain a transition metal hydroxide as a precursor.

Thereafter, a Li source (LiOH), a La source (La(OH)₃), and a W source (H₂WO₄) were added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. In addition, the addition amount of the La source was adjusted such that La/NCM was 0.005, and the addition amount of the W source was adjusted such that W/NCM was 0.005. The obtained first mixture was calcined in a calcining furnace under the conditions of 900° C., an oxygen atmosphere, and 10 hours to obtain a calcined product. The obtained calcined product was crushed using a jet mill to adjust the particle diameter, thereby obtaining a positive electrode active material.

### Preparation of Battery

A battery was prepared using the obtained positive electrode active material. Specifically, the positive electrode mixture paste was applied onto the surface of the metal foil, which was a positive electrode current collector, using a film applicator with a film thickness adjustment function (manufactured by Allgrid Co., Ltd.). The positive electrode mixture paste contained the positive electrode active material, a conductive material (acetylene black), and a binder (polyvinylidene fluoride) at a mass ratio of positive electrode active material:conductive material:binder=88:10:2. Thereafter, the positive electrode was dried at 80° C. for 5 minutes in a dryer to obtain a positive electrode having a positive electrode current collector and a positive electrode active material layer.

Next, the negative electrode mixture paste was applied onto the surface of the metal foil, which was a negative electrode current collector, using a film applicator with a film thickness adjustment function (manufactured by Allgrid Co., Ltd.). The negative electrode mixture paste contained a negative electrode active material (natural graphite) and a binder (SBR and CMC). Thereafter, the negative electrode was dried at 80° C. for 5 minutes in a dryer to obtain a negative electrode having a negative electrode current collector and a negative electrode active material layer. Next, as an electrolytic solution, a 1 M LiPF₆ solution was prepared. As a solvent of the electrolytic solution, a mixed solvent obtained by mixing ethylene carbonate (EC), dimethyl carbonate (DMC), and ethyl methyl carbonate (EMC) at a volume ratio of EC:DMC:EMC=3:4:3 was used. A wound cylindrical battery was obtained using the positive electrode, the negative electrode, and the electrolytic solution.

### Example 1

A precursor was obtained in the same manner as in Comparative Example 1, except that the reaction time was changed from 6 hours to 10 hours. A Li source (LiOH) and a W source (H₂WO₄) were added to the obtained precursor, and mixed with an agate mortar to obtain a first mixture. An addition amount of the Li source was adjusted such that a molar ratio (Li/NCM) of Li contained in the Li source to the total of Ni, Co, and Mn contained in the precursor (NCM) was 1.1. In addition, the addition amount of the W source was adjusted such that W/NCM was 0.005. The obtained first mixture was calcined in a calcining furnace under the conditions of 700° C., an oxygen atmosphere, and 10 hours to obtain a first calcined product.

The obtained first calcined product was crushed with an agate mortar. 100 ml of ion exchange water was put into a beaker, 30 g of the crushed first calcined product was added thereto while stirring with a stirrer, and the mixture was stirred at 1° C. for 30 minutes to be washed with water. Thereafter, the first calcined product was taken out by suction filtration and dried under the conditions of 120° C. and 16 hours. A La source (La(OH)₃) was added to the dried first calcined product, and mixed with an agate mortar to obtain a second mixture. The addition amount of the La source was adjusted such that La/NCM was 0.005. The obtained second mixture was calcined in a calcining furnace under the conditions of 650° C., an oxygen atmosphere, and 5 hours to obtain a second calcined product. The obtained second calcined product was crushed using a jet mill to adjust the particle diameter, thereby obtaining a positive electrode active material. A battery was obtained in the same manner as in Comparative Example 1, except that the obtained positive electrode active material was used.

### Example 2

A precursor was obtained in the same manner as in Comparative Example 1, except that the reaction time was changed from 6 hours to 3 hours. Positive electrode active material and a battery were obtained in the same manner as in Example 1, except that the obtained precursor was used and the temperature during the water washing was changed to 2.5° C.

### Example 3

A precursor was obtained in the same manner as in Comparative Example 1, except that the reaction time was changed from 6 hours to 3 hours. Positive electrode active material and a battery were obtained in the same manner as in Example 1, except that the obtained precursor was used and the temperature during the water washing was changed to 4° C.

### Comparative Example 2

A precursor was obtained in the same manner as in Comparative Example 1, except that the reaction time was changed from 6 hours to 3 hours. Positive electrode active material and a battery were obtained in the same manner as in Example 1, except that the obtained precursor was used and the temperature during the water washing was changed to 7° C.

### Evaluation

### SEM-EDX Measurement

For the positive electrode active materials obtained in Examples 1 to 3 and Comparative Examples 1 and 2, a cross-sectional observation and an element analysis were performed by scanning electron microscope-energy dispersive X-ray spectroscopy (SEM-EDX). As a result, in Examples 1 to 3 and Comparative Example 2, the particle-shaped compound was confirmed on the surface of the primary particles, and from the mapping image, it was confirmed that the particle-shaped compound contained La, Ni, and O. On the other hand, in Comparative Example 1, the particle-shaped compound was not confirmed on the surface of the primary particles.

### TEM-EDX Measurement

For the positive electrode active materials obtained in Examples 1 to 3 and Comparative Example 2, a cross-sectional observation and an element analysis were performed by transmission electron microscope-energy dispersive X-ray spectroscopy (TEM-EDX). As a result, on the surface of the primary particles in Examples 1 to 3 and Comparative Example 2, a film-shaped compound was confirmed, and from the mapping image, it was confirmed that the film-shaped compound contained W and O. On the other hand, in Comparative Example 1, the film-shaped compound was not confirmed on the surface of the primary particles.

### Pore Size Distribution Measurement

For the positive electrode active materials obtained in Examples 1 to 3 and Comparative Examples 1 and 2, a pore size distribution was measured by mercury intrusion porosimetry. Specifically, the pore size distribution of the positive electrode active material was measured by injecting mercury into a sample tube in which 1 g of the positive electrode active material was sealed, using a mercury intrusion type pore size distribution measuring device manufactured by Micromeritics Instrument Corporation. In Examples 1 to 3 and Comparative Example 2, since the positive electrode active material which was a polycrystal was obtained, the peak was present at 65 nm or less. On the other hand, in Comparative Example 1, since the single crystal positive electrode active material was obtained, the above-described peak was not present. Table 1 shows the results of the peak position.

### Initial Resistance

The initial resistance was measured using the batteries obtained in Examples 1 to 3 and Comparative Examples 1 and 2. Specifically, the above-described battery was charged to 4.3 V, and then discharged to 3.7 V. Thereafter, the voltage drop (V) in a case of discharging for 10 seconds under the conditions of each C-rate of 0.1C, 0.3C, 0.5C, 0.7C, and 1.0C at 25° C. was measured. A relationship between the voltage drop (V) and the current value was plotted, and a slope in a case where an approximate straight line was drawn by a linear function was defined as a resistance (IV resistance). The results are listed in Table 2. The value of the initial resistance in Table 2 is a relative value in a case where the initial resistance of Comparative Example 1 is 100%.

### Cycle Resistance Increase Rate

The cycle resistance increase rate was measured using the batteries obtained in Examples 1 to 3 and Comparative Examples 1 and 2. Specifically, the resistance (IV resistance) before and after the cycle test was measured. The cycle test was performed for 100 cycles under the conditions of a voltage range of 3.0 V to 4.3 V, a C-rate of 0.3C, a mode of CC charging and discharging, and a temperature of 50° C., and the cycle resistance increase rate was determined based on the following expression.

$$Cycle resistance increase rate ( \% ) = ( Resistance after cycle test ) / Initial resistance \times 100$$

The results are listed in Table 2.

TABLE 1

| | | | | | | | | | Peak |
|---|---|---|---|---|---|---|---|---|---|
| | Ratio | | | | | | Compound | | position |
| | Li | Ni | Co | Mn | La | W | A | B | (nm) |
| Comparative | 1.1 | 0.8 | 0.1 | 0.1 | 0.005 | 0.005 | — | — | — |
| Example 1 | | | | | | | | | |
| Example 1 | 1.1 | 0.8 | 0.1 | 0.1 | 0.005 | 0.005 | ◯ | ◯ | 23 |
| Example 2 | 1.1 | 0.8 | 0.1 | 0.1 | 0.005 | 0.005 | ◯ | ◯ | 26 |
| Example 3 | 1.1 | 0.8 | 0.1 | 0.1 | 0.005 | 0.005 | ◯ | ◯ | 24 |
| Comparative | 1.1 | 0.8 | 0.1 | 0.1 | 0.005 | 0.005 | ◯ | ◯ | 22 |
| Example 2 | | | | | | | | | |

TABLE 2

| | | | | | | Cycle |
|---|---|---|---|---|---|---|
| | Particle diameter | | | | Initial | resistance |
| | | | d50/ | (d90 − | resistance | increase |
| | d50 | Dave | Dave | d10)/d50 | (%) | rate (%) |
| Comparative | 0.1 | 5 | 0.02 | 0.3 | 100 | 123 |
| Example 1 | | | | | | |
| Example 1 | 0.5 | 20 | 0.03 | 0.4 | 82 | 109 |
| Example 2 | 2 | 2 | 1.00 | 3.9 | 79 | 108 |
| Example 3 | 3 | 2 | 1.50 | 3.5 | 78 | 110 |
| Comparative | 5 | 2 | 2.50 | 3.2 | 102 | 135 |
| Example 2 | | | | | | |

As shown in Table 2, it was confirmed that Examples 1 to 3 had a lower initial resistance than Comparative Example 1. It is presumed that this is because, since the compound A having favorable electron conductivity and the compound B having favorable ion conductivity are present on the surface of the primary particles, the movement of electrons and ions is smooth. The compound A contains La, Ni, and O. The compound B contains Li, W, and O. Further, it is presumed that, in Examples 1 to 3, since d₅₀/Dₐᵥₑ is in a predetermined range, the effect of improving the electron conductivity by the compound A is further exhibited. In addition, it was confirmed that Examples 1 to 3 had a lower initial resistance than Comparative Example 2. It is suggested that, in a case where d₅₀/Dₐᵥₑ is too large, the effect of improving the ion conductivity by the compound A is hardly exhibited. In addition, it was confirmed that Examples 1 to 3 had a lower cycle resistance increase rate than Comparative Example 1. It is presumed that this is because the positive electrode active material (polycrystal) obtained in Examples 1 to 3 has a smaller specific surface area than the positive electrode active material obtained in Comparative Example 1 (single crystal), and the accumulation of the resistance component due to repeated charging and discharging can be suppressed.

What is claimed is:

1. A positive electrode active material comprising primary particles that have crystallinity, the primary particles containing Li, a transition metal (TM), and O, wherein:
the positive electrode active material is a polycrystal made of the primary particles;
a compound A containing La, Ni, and O and having a particle shape and a compound B containing Li, W, and O are present on a surface of the primary particles;
a peak is present at 65 nm or less in a pore size distribution obtained by mercury intrusion porosimetry; and
in a case where an average particle diameter of the polycrystal is defined as Dₐᵥₑ and a cumulative 50% particle diameter of the compound A is defined as d₅₀, the positive electrode active material satisfies 0.025≤d₅₀/Dₐᵥₑ≤2.0.

2. The positive electrode active material according to claim 1, wherein the primary particles contain, as the TM, at least one of Ni, Co, and Mn.

3. The positive electrode active material according to claim 1, wherein at least one of the compound A and the compound B is present at an interface between the primary particles adjacent to each other in the polycrystal.

4. The positive electrode active material according to claim 1, wherein the compound B has a film shape.

5. A battery comprising:
a positive electrode active material layer containing a positive electrode active material;
a negative electrode active material layer containing a negative electrode active material; and
an electrolyte layer disposed between the positive electrode active material layer and the negative electrode active material layer,
wherein the positive electrode active material layer contains the positive electrode active material according to claim 1.
